(19) United States
(12) Patent Application Publication
(10) Pub. No.: US 2001/0053267 A1
(43) Pub. Date: Dec. 20, 2001

(54) Optical transmitting and receiving device

(76) Inventors: Elmar Baur, Regensburg (DE); Hans Hurt, Regensburg (DE); Gustav Muller, Regensburg (DE); Klaus Panzer, Regensburg (DE); Robert Staudinger, Irlbach (DE); Josef Wittl, Parsberg (DE)

Correspondence Address: LERNER AND GREENBERG, P.A., Post Office Box 2480, Hollywood, FL, 33022-2480, US

(21) Appl. No.: 09/765,214

(22) Filed: Jan. 18, 2001

(30) Foreign Application Priority Data
Jan. 18, 2000 (DE) 100 01 873.4

(51) Int. Cl. G02B 6/43

(52) U.S. Cl. 385/89; 385/88

(57) ABSTRACT

For the configuration of an optical transmitting and receiving device (optical transceiver), an optical transmitter and an optical receiver are integrated in a single module with preferably two optical connections. For this purpose, the optical transmitter and the optical receiver are mounted on a common support and accommodated in a common housing, the optical transmitter preferably is disposed in one chamber of the housing and the optical receiver in another chamber of the housing, in order to avoid electrical and optical cross-talk between transmitter and receiver.

### BACKGROUND OF THE INVENTION

### Field of the Invention

The present invention relates to an optical transmitting and receiving device having a housing in which an optical transmitting unit and an optical receiving unit are disposed.

As the development of optical wave guide technology advances, the compact configuration of the optical transmitters and optical receivers required for optical data transmission becomes more and more important.

Therefore, combined optical transmitting and receiving devices, so-called optical transceivers, have been developed. In these known optical transmitting and receiving devices, two separate optical modules or components are used as the transmitter and the receiver. A respective support, also referred to as a “lead frame” is used for the optical transmitter and the optical receiver. The support is populated with the optical/electrical components assigned to the transmitter and receiver, respectively. The term “lead frame” can be used generally to denote a support that undertakes line routing within the corresponding module. What may be involved here, in particular, is a stamped or etched metal support or, for example, also a printed circuit board. After the two lead frames have been populated, they and the corresponding mounted optical/electrical components are potted with resin (so-called packaging), in order to obtain a transmitter module and a receiver module. The two modules produced in this way can be mounted in a surrounding housing, configured as a connector housing, to form a unit. Moreover, the two modules can be provided with a screening plate in order to avoid electromagnetic effects.

### Summary of the Invention

It is accordingly an object of the invention to provide an optical transmitting and receiving device which overcomes the above-mentioned disadvantages of the prior art devices of this general type, in which the size of the overall device is reduced.

With the foregoing and other objects in view there is provided, in accordance with the invention, an optical transmitting and receiving device which includes: a common housing having a common support; an optical transmitting unit mounted on the common support in the common housing; and an optical receiving unit mounted on the common support in the common housing.

According to the invention, the optical transmitter and the optical receiver are integrated in a single module, the optical/electrical components of the transmitter and of the receiver are mounted on the single common lead frame or support and accommodated in the common housing.

The housing may be configured, in particular, in the form of a connector housing, with connection pins for the transmitter and the receiver projecting from the underside of the housing. In this case, a common earth connection pin may be provided for the transmitter and the receiver.

The housing preferably has two separate chambers, the transmitter being accommodated in one chamber and the receiver in the other chamber, so that optical cross talk between the transmitter and the receiver is not possible. In order to screen the module, a screening plate may be used and/or the housing may be produced from a conductive plastic material, an electroplated material or metal.

Since, according to the invention, the optical transmitter and the optical receiver are configured in the form of the single module on the common support, the overall size of the optical transmitting and receiving device can be distinctly reduced. Moreover, only a so-called “Cavity As Interface” (CAI) housing is necessary.

In accordance with an added feature of the invention, a common screening plate encloses the optical transmitting unit and the optical receiving unit. The common screening plate has a section disposed between the optical transmitting unit and the optical receiving unit.

In accordance with an additional feature of the invention, the common housing has two chambers, including a first chamber and a second chamber, separated by a partition. The optical transmitting unit is disposed in the first chamber and the optical receiving unit is disposed in the second chamber.

In accordance with another feature of the invention, the common housing has a first optical connection, associated with the optical transmitting unit, and a second optical connection associated with the receiving unit, for respectively connecting to a corresponding optical wave guide.

In accordance with a further feature of the invention, the common housing has first electrical plug connecting means, associated with the optical transmitting unit, and second electrical plug connecting means, associated with the optical receiving unit.

In accordance with another additional feature of the invention, the first electrical plug connecting means and the second electrical plug connecting means each contain connection pins projecting from the common housing.

In accordance with a concomitant feature of the invention, the first electrical plug connecting means and the second electrical plug connecting means have a common earth connection pin for the optical transmitting unit and the optical receiving unit.

Other features which are considered as characteristic for the invention are set forth in the appended claims.

Although the invention is illustrated and described herein as embodied in an optical transmitting and receiving device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, front-elevational view of a first exemplary embodiment of an optical transmitting and receiving device according to the invention;

FIG. 1B is a side-elevational view of the optical transmitting and receiving device shown in FIG. 1A;

FIG. 2A is a diagrammatic, front-elevational view of a second exemplary embodiment of the optical transmitting and receiving device according to the invention; and

FIG. 2B is a side-elevational view of the optical transmitting and receiving device shown in FIG. 2a.

### DESCRIPTION OF THE PREFERRED EMBODIMENTS

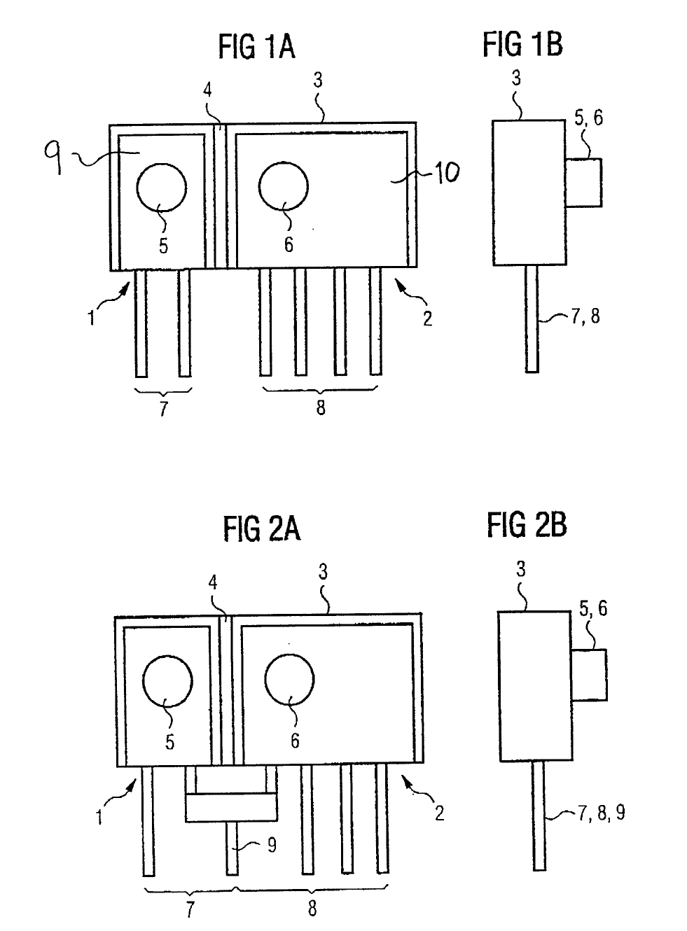

In all the figures of the drawing, sub-features and integral parts that correspond to one another bear the same reference symbol in each case. Referring now to the figures of the drawing in detail and first, particularly, to FIGS. 1A and 1B thereof, there is shown an optical transmitting and receiving device which has a housing 3 configured with two chambers. An optical transmitter 1 is situated in a left-hand chamber 9 in

FIG. 1A, while the optical receiver 2 is accommodated in a right-hand chamber 10. Each of the chambers 9, 10 in the housing 3 is assigned an optical connection 5, 6 for a corresponding optical wave guide or a corresponding optical fiber.

The optical/electrical components of the transmitter 1 and of the receiver 2 are mounted on a common “lead frame” or support disposed in the housing 3. The two chambers 9, 10 are separated from one another by a partition 4, so that optical cross-talk between the optical transmitter 1 and the optical receiver 2 can be reliably avoided.

Electrical connections 7 and 8 for the optical transmitter 1 and the optical receiver 2, respectively, are formed on the underside of the common housing 3. In the exemplary embodiment illustrated, the housing 3 is configured in the form of a connector housing, so that the connections are realized in the form of connection pins which project from the underside of the housing 3 and are connected to the common support or the corresponding components (respectively mounted thereon) of the optical transmitter 1 and the optical receiver 2, respectively. With regard to the optical transmitter 1, just two connection pins 7 are provided as anode and cathode of the corresponding electro-optical transducer. With regard to the optical receiver 2, by contrast, four connection pins 8 are provided, two connection pins being provided as anode and cathode for the corresponding opto-electrical transducer and two connection pins being provided for an integrated circuit (IC) which is usually connected downstream of the opto-electrical transducer. Since the chamber-type housing 3 thus serves simultaneously as an electrical interface for the corresponding components of the optical transmitter 1 and the optical receiver 2, this type of housing can also be referred to as a so-called “Cavity As Interface”—or CAI—housing.

The optical transmitter 1, the optical receiver 2 and the housing 3 thus form a single module. In order to prevent electromagnetic effects, the complete module may be enclosed by a screening plate, in which case, in particular, the corresponding section or a lug of the screening plate is disposed between the optical transmitter 1 and the optical receiver 2, thereby avoiding electromagnetic interactions between the optical transmitter 1 and the optical receiver 2.

Furthermore, in order to avoid electromagnetic effects, the housing 3 (and thus also the partition 4 formed integrally with the housing) can be produced from an electrically conductive plastics material, from an electroplated material or from metal.

FIGS. 2A and 2B illustrate the optical transmitting and receiving device (optical transceiver) in accordance with a second exemplary embodiment of the present invention. This exemplary embodiment differs from the exemplary embodiment shown in FIGS. 1A and 1B merely by the fact that a common earth connection pin 9 is provided for the optical transmitter 1 and the optical receiver 2. This configuration makes it possible to achieve an even more compact form of the overall module and also a reduction of the production costs.

We claim:

1. An optical transmitting and receiving device, comprising:
a common housing having a common support;
an optical transmitting unit mounted on said common support in said common housing; and
an optical receiving unit mounted on said common support in said common housing.

2. The optical transmitting and receiving device according to claim 1, including a common screening plate enclosing said optical transmitting unit and said optical receiving unit, said common screening plate having a section disposed between said optical transmitting unit and said optical receiving unit.

3. The optical transmitting and receiving device according to claim 1,
including a partition; and
wherein said common housing has two chambers, including a first chamber and a second chamber, separated by said partition, said optical transmitting unit is disposed in said first chamber and said optical receiving unit is disposed in said second chamber.

4. The optical transmitting and receiving device according to claim 1, wherein said common housing is produced from an electrically conductive plastic material.

5. The optical transmitting and receiving device according to claim 1, wherein said common housing is produced from an electroplated material.

6. The optical transmitting and receiving device according to claim 1, wherein said common housing is produced from metal.

7. The optical transmitting and receiving device according to claim 1, wherein said common housing has a first optical connection, associated with said optical transmitting unit, and a second optical connection associated with said receiving unit, for respectively connecting to a corresponding optical wave guide.

8. The optical transmitting and receiving device according to claim 1, wherein said common housing has first electrical plug connecting means, associated with said optical transmitting unit, and second electrical plug connecting means, associated with said optical receiving unit.

9. The optical transmitting and receiving device according to claim 8, wherein said first electrical plug connecting means and said second electrical plug connecting means each contain connection pins projecting from said common housing.

10. The optical transmitting and receiving device according to claim 9, wherein said first electrical plug connecting means and said second electrical plug connecting means have a common earth connection pin for said optical transmitting unit and said optical receiving unit.
